(19) United States
(12) Patent Application Publication
(10) Pub. No.: US 2002/0074853 A1
(43) Pub. Date: Jun. 20, 2002

(54) Spoked bicycle wheel

(76) Inventor: Jiri Krampera, Zurich (CH)

Correspondence Address: RANKIN, HILL, PORTER & CLARK, LLP, 700 HUNTINGTON BUILDING, 925 EUCLID AVENUE, CLEVELAND, OH, 44115-1405, US

(21) Appl. No.: 10/022,669

(22) Filed: Dec. 17, 2001

(30) Foreign Application Priority Data
Dec. 19, 2000 (CH) 2476/00
Nov. 22, 2001 (CH) 2151/01

(51) Int. Cl. B60B 1/02

(52) U.S. Cl. 301/55

(57) ABSTRACT

An in accordance with every embodiment of the invention eccentrically spoked bicycle front wheel or bicycle rear wheel on its sides has an unequal number of spokes, but a practically equal or exactly equal average tension of the spokes. For several reasons, this wheel in operation is significantly more durable than a comparable conventional eccentrically spoked bicycle front wheel or bicycle rear wheel, which on its sides has an equal number of spokes, but significantly unequal average tensions of the spokes.

A centrically spoked bicycle front wheel according to a different embodiment of the invention with identical numbers and tensions of spokes on both its sides is more durable in operation than a comparable conventional centrically spoked bicycle front wheel, however due to different reasons than an eccentrically spoked wheel.

### STATE OF PRIOR ART

The invention concerns a spoked bicycle wheel, preferably an eccentrically spoked bicycle wheel, the spoke system of which has an amount of dish in the axial section of the wheel, such that the spoke tensions are different on each side of the wheel. (The inventor has previously already dealt with a similar subject in his patents ,,Rim for a spoked bicycle rear wheel,,). This wheel can be used as a bicycle front or rear wheel.

A conventional bicycle front wheel of this kind has a front wheel hub, which is fixed in the fork of the bicycle frame and on one side of which, e.g., a brake disc is affixed as a component part of a disc brake. A conventional bicycle rear wheel of this kind has a rear wheel hub, which is fixed in the bicycle frame and on one side of which a sprocket set for the drive chain is affixed. The hub flanges on the sides of the front and rear wheel hubs are connected by means of spokes under tension to a conventional wheel rim, which carries a tire.

In a rear wheel the sprocket set causes an undesirable lateral displacement of the center plane of the hub flanges in relation from the center plane of the rim in the direction of the opposite side of the sprocket set. As a result of this displacement amounting to several millimeters, which is known as amount of dish, the tension of the spokes on the sprocket set side is greater than the tension of the spokes on the opposite side to such a degree, that the durability (under stress) of the rear wheel is considerably diminished. For this reason it is desirable, that the spoke tensions of the rear wheel are equalized to as great an extent as possible.

In the case of a front wheel, the lateral displacement of the center plane of the hub flanges is caused as a result of the lateral fixing of the brake disc to the hub and here too, an equalization of the spoke tensions on both sides of the wheel is desirable.

Every specialist today is aware of the following problem in the case of the conventional bicycle rear wheel. A rear wheel today with 8 to 10 sprockets, in which the spoke tension is grater by approximately 100% and more (!) on the sprocket set side of the wheel than on the other side of the wheel, cannot maintain a desirable average tension of all spokes. This is all the more so, as the differences in the tensions of individual spokes on one side of the wheel in comparison with the average are known to amount up to approximately ±200 to 300 N. The result is a rear wheel, which frequently has to be re-centered, because individual nipples of the too loose spokes on the opposite side of the sprocket set become loose in operation. The highly tensioned spokes on the sprocket set side, however, cannot be re-tensioned sufficiently to help the spokes on the opposite side of the sprocket set to a greater tension, because their nipples, e.g., during the powerful re-tensioning with the centering spanner are torn apart or their square neck is torn off. Apart from this, in operation almost always only the spokes on the sprocket set side break as a result of fatigue. In consequence, even in the case of very expensive racing bicycles all conventional rear wheels are inferior.

Innumerable spoke arrangements for eccentrically spoked bicycle wheels are known today. These are said to provide the most diverse advantages. All systems, however, have a common characteristic: The number of spokes, which lead from one hub flange to the wheel rim, is the same as the number of spokes, which lead from the other hub flange on the other side of the hub to the wheel rim. It is precisely this characteristic, which perforce makes, in the case of an eccentrically spoked wheel, the average tensions of the spokes on both sides of the wheel different.

During the past years, various measures have been taken to try to equalize the differing tensions on the two wheel sides. For example, asymmetrical rims with laterally displaced spoke anchorings have been described in the European patent No. 0494277 or U.S. Pat. No. 5,228,756 or Japanese Pat. No. 3111074 respectively. By means of these solutions, the spoke tensions on both sides of the wheel became significantly more balanced. As various tests of the licensees prove, wheels with rims of this type are more resistant than wheels with conventional rims. At the present moment, running wheels with this type of rims are being used for bicycle rear wheels with several sprockets as well as for front wheels with brake discs.

### ABSTRACT OF THE INVENTION

It is the object of the present invention to create an eccentrically spoked bicycle wheel, which, in comparison with a conventional eccentrically spoked wheel with the same amount of dish, the same hub, the same rim and the same number of spokes has almost or even exactly the same tensions of the spokes on both sides of the wheel and which therefore is much more durable. This—at first glance not implementable task—is accomplished in the most simple manner by a spoked wheel with the characterizing features of the claim 1. This wheel has a different number of spokes on each side in accordance with the following principle: A greater average tension of the spokes on one side of the wheel is eliminated by a greater number of spokes on this side. The remaining questions, as to whether a system of this kind can be spoked into a wheel at all and as to whether such a wheel can be centered at all, are answered in the affirmative.

### BRIEF DESCRIPTION OF THE DRAWINGS

In the following, first of all, the field of problems raised by a bicycle rear wheel using conventional spoking is explained. The field of problems in dealing with a bicycle front wheel is analogous and therefore not explained separately. Subsequently, various embodiments of the invention are explained in detail. In schematic illustrations the figures depict:

FIG. 1 a part of a conventionally eccentrically spoked bicycle rear wheel in the axial sectional view in accordance with prior art;

FIG. 2 a conventionally eccentrically spoked bicycle front or rear wheel in side view in accordance with prior art;

FIG. 3 a part of an eccentrically spoked bicycle rear wheel in the axial sectional view similar as in FIG. 1, however, in accordance with an embodiment of the invention;

FIGS. 4-9 an eccentrically spoked bicycle front wheel or bicycle rear wheel in side view similar as in FIG. 2, however, in accordance with different embodiments of the invention.

FIG. 10 a symmetrically spoked bicycle front wheel in side view similar as in FIG. 2 according to a further embodiment of the invention.

### DETAILED DESCRIPTION OF THE ADVANTAGEOUS EMBODIMENTS OF THE INVENTION

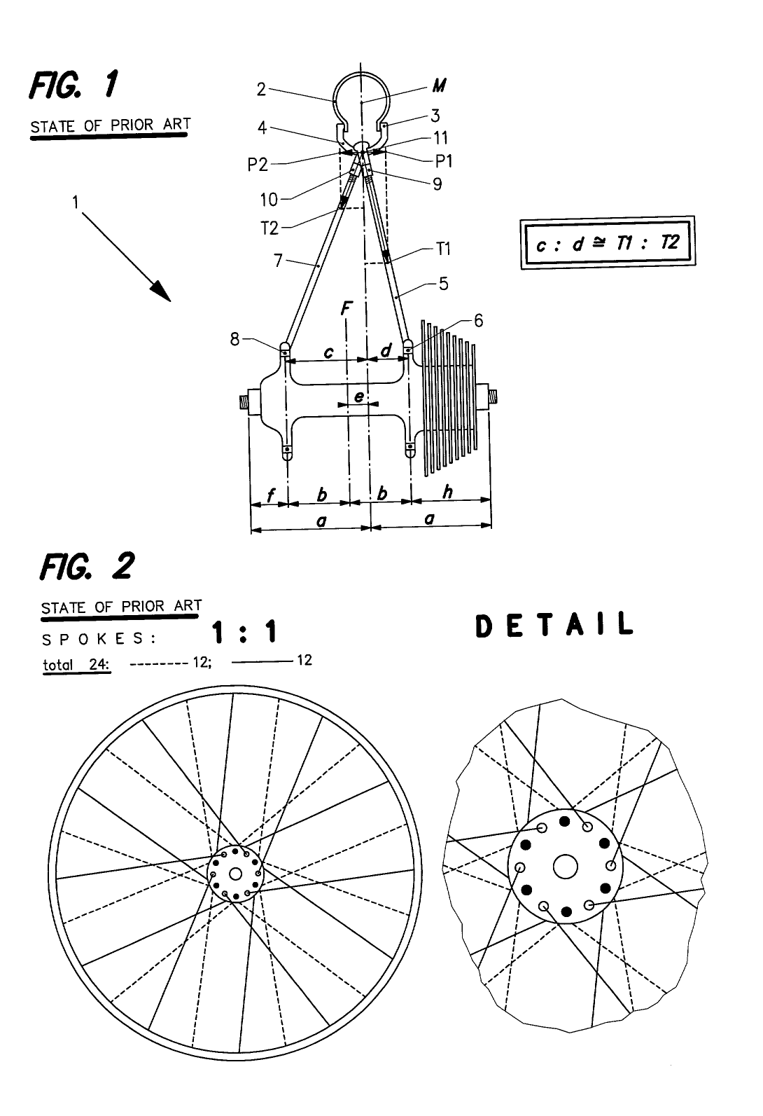

FIG. 1 shows a part of a conventional eccentrically spoked bicycle rear wheel 1 in axial sectional view in accordance with prior art.

The tire 2 is mounted on a conventional wheel rim 3 with a symmetrical cross section in relation to the center plane of the wheel rim M and a simple wheel rim bottom 4. Today, wheel rims with double rim bottom and with the most diverse, also asymmetrical cross sections, are increasingly used.

The wheel rim 3, by means of spokes 5 on the sprocket set side, is connected with the hub flange on the sprocket set side in the anchoring points 6 and by means of spokes 7 on the opposite side of the sprocket set to the hub flange on the opposite side of the sprocket set in the anchoring points 8. The anchoring of the spokes in the hub flanges in most instances is implemented in the spoke holes, whereby the spokes have a rectangular bend and a spoke head at their ends. For reasons of clarity, this detail is not illustrated. The hub flanges are connected to each other by means of a cylindrical hub body.

The anchoring of the spokes in the wheel rim is implemented in the center of the wheel rim by means of spoke nipples 9, 10 in the points 11. Today, these anchoring points are not always located in the center of the wheel rim and, for example, all spokes are anchored in a laterally displaced position in relation to the center plane M of the wheel rim in the half of the wheel rim on the opposite side to the sprocket set. Or else the spokes on the sprocket set side are anchored in the half of the wheel rim opposite the sprocket set and vice versa, such that the spokes on the sprocket set side and on the side opposite the sprocket set intersect in the axial sectional view of the wheel. The object of systems of this type is an improvement of the lateral rigidity of the wheel and of the ratio of the spoke tensions on the wheel sides.

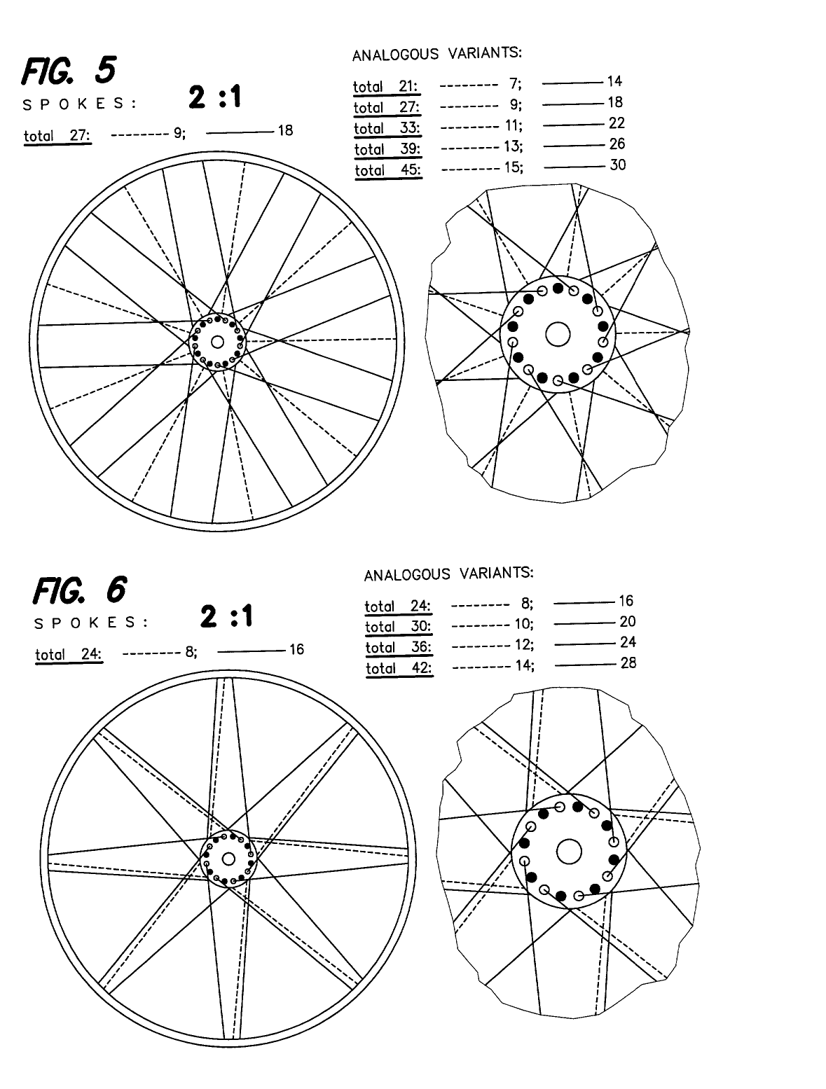

The spoke nipples 9, 10 today are sometimes located in the hub flanges instead of in the wheel rim. The hub flanges are also not always designed in ring-shape, but, for example spokes, which are straight over their whole length, are anchored on the circumference of the hub in various tooth-shaped structures, such that the risk of a fracture in the bend of the spoke is eliminated. When centering the wheel by the turning of the spoke nipples 9, 10, tensions T1, T2 are created in the spokes 5, 7, which compressively stress the material of the wheel rim and that of the hub in the spoke anchoring points 11, 6 , 8. The very important ratio of average spoke tensions on both sides of the wheel is dependent on the one hand on the ratio of the angles between the spokes 5, 7 and on the other hand on the center plane of the anchoring points of the spokes in the wheel rim. In this example (and also in FIG. 3) the center plane of the anchorage points of the spokes in the wheel rim is identical to the center plane of rim M. (It is not, however, identical in wheels with laterally displaced spoke anchoring points in the rim.) The tensions of the spokes in FIG. 1 are graphically illustrated as line sections T1 and T2, which are in an approximate ratio of 2:1 to one another. Today, in the case of sevenfold and multiple sprocket sets, this leads to a very deficient lateral rigidity of the rear wheel in the direction from the sprocket set side to the side of the wheel opposite the sprocket set and it leads to continuous loosening of the spoke nipples on the side opposite the sprocket set. It can be mathematically proved and has been substantiated by practical measurement, that the ratio of the spoke tensions T1:T2 reasonably accurately corresponds to the ratio of the dimensions c:d on the hub.

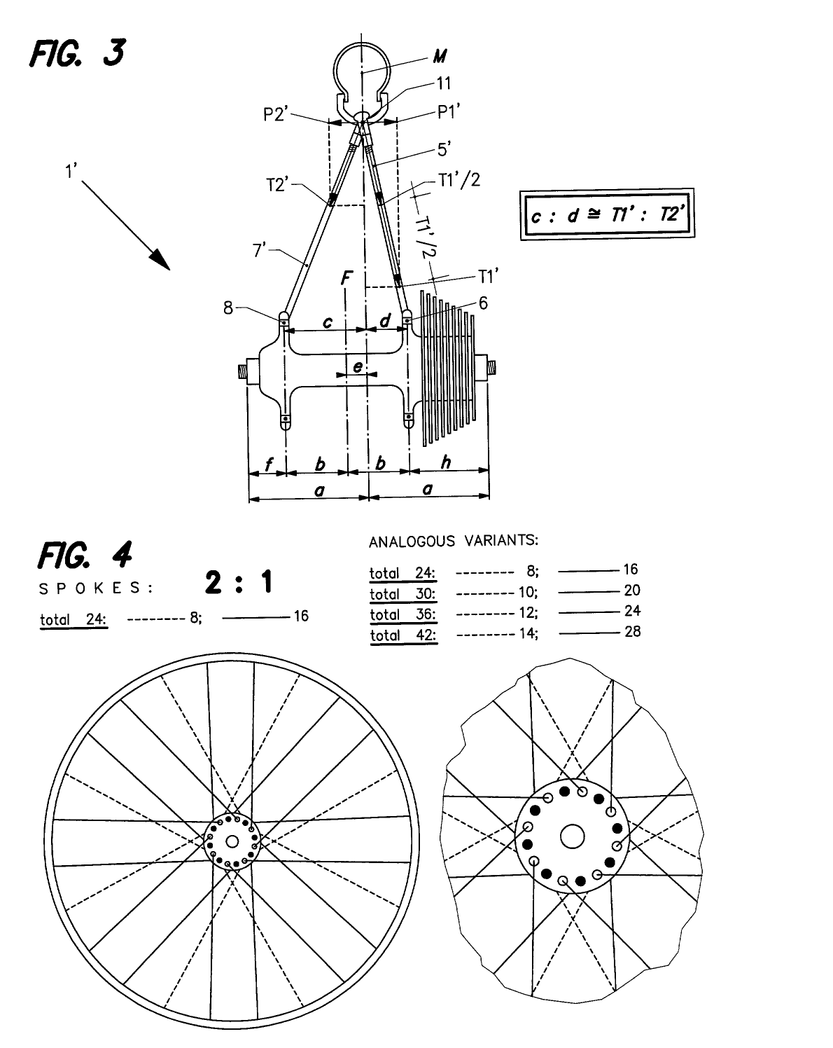

This rule is applicable if the spoke anchoring points in the rim are in its middle and if the spokes are spoked crosswise on both sides of the wheel. Hereby, the spokes with rectangular bends at their ends are inserted into the spoke holes alternately in both flanges, such that they emerge from the flange alternately from both sides in the direction of the wheel rim. The mechanical effect of this system of spoking is such that all spokes from both flanges are brought from the center of the spoke hole from the points 6 and 8 to the wheel rim, as is illustrated in a simplified manner in FIG. 1. The wheels in the FIGS. 2, 4 and 6 have crossed spokes on both sides. This can be seen very well in the enlargements of the hub flanges in these Figures. In the case of the FIGS. 5, 7, 8 and 9 it is, however, different than is described in connection with FIGS. 2, 4 and 6.

The dimensions c and d can be measured and the conventional ratio of the spoke tensions calculated easily upon which a suitable spoke system can be chosen with the help of the described method. This should result in a spoke tension which approaches the ideal ratio of 1:1 to as great an extent as possible and/or as desired. The horizontal force components P1 and P2 of the spoke tensions T1 and T2 created during the centering of the wheel can become smaller or larger depending on the values of T1 and T2, they are, however, perforce always of the same value in a wheel.

The anchoring points 11 of the spoke nipples are located in the rim center plane M in this example. (This, however, is not always the case, as is manifested in the patent “Rim for a spoked bicycle rear wheel” mentioned on page 2.) The center plane of the wheel hub flanges F is laterally displaced from the center plane of the rim M in the direction of the side of the hub opposite to the sprocket set side by the dimensional value e, as a result of which the spoke system has an eccentric shape. The dimension e=(h−f):2 is the actually undesirable amount of dish of the spoke system and the reason for the imperfection of the wheel.

In complement it shall be stated, that in the case of a conventional bicycle front wheel without a brake disc the spoke system is centered, such that the planes M and F are identical and no amount of dish e is produced. Wheels of this type have the same spoke tension on both sides, so that c=d and T1:T2=1:1. This is the ideal case and these wheels in operation are more durable by a multiple figure than the spoked wheels with an eccentric system of spokes.

FIG. 2 depicts a conventional eccentrically spoked bicycle front wheel or bicycle rear wheel in side view according to prior art. The rear wheel 1 of this kind was illustrated in the axial sectional view in FIG. 1. The tire, sprocket set and brake disc are not shown, in order to illustrate solely the essential.

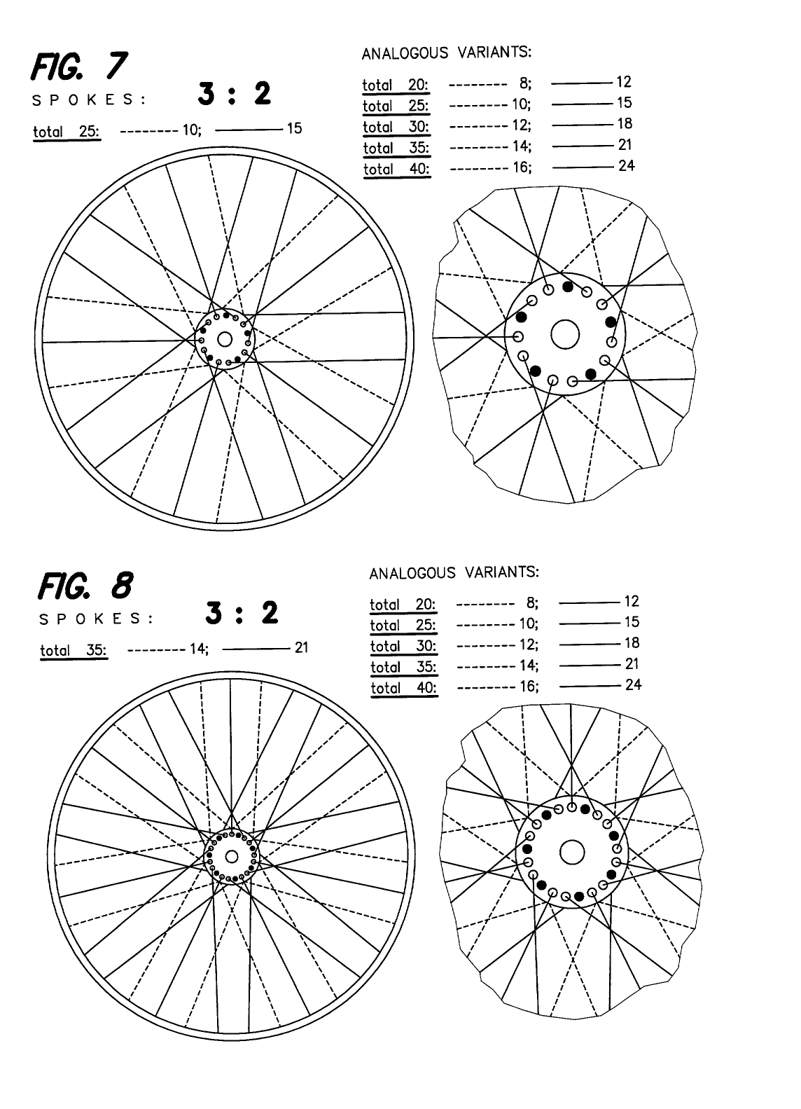

The wheel has a total of 24 spokes which are crossed twice on both sides of the wheel. The spokes on the side of the wheel facing the viewer are represented by means of unbroken lines, the spokes on the other side of the wheel are represented by broken lines. The intersection of the spokes on both sides serves for better transmission of the torque generated by the chain drive or by the braking process from both flanges of the wheel hub through the spokes to the wheel rim. This additional tensile stress is therefore distributed over more spokes than if a flange solely has radial spokes, which cannot transmit any torque (in so-called hybrid running wheels). A detail of the flange provides better visibility of the layout of the spokes. A similar detail is also to be seen in the FIGS. 4, 5, 6, 7, 8, 9 and 10.

The most important point to consider is the fact, that the number of spokes according to this Figure is the same on both sides of the wheel and in this example amounts to 12 and therefore the spoke number ratio of the spokes 5 to the spokes 7 amounts to 1:1. Although at the present moment in the case of bicycles innumerable spoke mounting systems are in existence, this fundamental principle is maintained in the case of every wheel, which is spoked conventionally. The number of the spokes on both sides of the wheel is the same. If hereby the average spoke tension ratio T1:T2 amounts to approximately 2:1, as is graphically illustrated in FIG. 1, then on average every spoke on the sprocket set—or brake disc side of the wheel has to resist a two-times higher tension than every spoke on the other side of the wheel. Therefore the structure of the wheel is not well balanced. This kind of wheel frequently becomes subject to lateral wobbling and requires additional centering. Under continuous duty serious damage occurs due to the alternating stress on the individual components of the wheel, such as e.g. every second nipple bore in the rim tearing out, the spokes breaking on the sprocket-side of the wheel, the flanges tearing off on the sprocket-side of the hub etc.

FIG. 3 illustrates a part of an eccentrically spoked bicycle wheel 1′ in the axial sectional view in accordance with one possible embodiment of the invention. The graphic depiction of the wheel corresponds to FIG. 1 and therefore for reasons of a clearer view numbers and pointer lines to several components are left away and only the changes in comparison with FIG. 1 are emphasized.

It is evident, that the spoke tensions T1′ and T2′ and perforce also their horizontal force components P1′ and P2′ have become greater in comparison with FIG. 1. In the case of the wheel 1 in FIG. 1, with the ratio of the dimensions c:d=2:1 and the ratio of the number of spokes on the sides of the wheel of 1:1, the average tension of all spokes in the wheel is insufficient and from experience amounts to a maximum of 700 N. The wheel is therefore inferior due to reasons described previously. In the case of the wheel 1′, however, one can, in the case of c:d=2:1 and even with the same total number of spokes as in the case of the wheel 1 easily achieve a higher average tension of all spokes of approximately 1′000 N and more. This tension, however, cannot be increased at choice as will be explained below.

The procedure is as follows: the number of spokes is increased on the sprocket set side of the wheel and simultaneously reduced on the opposite side of the wheel, such that the ratio of the number of spokes on the sides of the wheel is 1:2 in this example. In this manner, a spoke tension ratio of the sides of the wheel of 1:1 is produced, as in the case of a centrically spoked front wheel. Succinctly expressed: the two-times greater tension of the spokes on the side of the wheel with the sprocket set is equalized there by means of using twice as many spokes. This condition is graphically illustrated in FIG. 3 in such a manner, that the line sector T1′ is split-up into two equal sectors T1′/2 and T1′/2. Each one of these represents a whole spoke and corresponds to the line sector T2′. The conditions in this rear wheel, however, are not the same as in the case of a centrically spoked front wheel.

The compressive stressing of the material in the anchoring points of the spokes in the rims and in the hub are now the same on both sides of the wheel and also the settling phenomena in the case of the spoke heads or of the nipples, which take place within a few tenths of a millimeter, have as a result of this become equal. The minimum and maximum tensions of the individual spokes in the whole wheel now are situated within the permissible range—even in the case of a divergence of ±200 to 300 N. The heads of the spoke nipples now have sufficient friction on their substrate and the nipples cannot become loose by themselves. The spokes, however, are not excessively tensioned, such that the centering can now proceed without problems and they do not break even after long periods under stress. As a result, the structure of the wheel is well balanced which makes the wheel very stable and only rarely is subject to lateral wobbling. Damage under continuous duty, as described in connection with FIG. 2, is impossible under these circumstances.

The important lateral rigidity of the wheel from the side of the sprocket set—or from the side of the brake disk—has increased, because the overall spoke tension in the wheel has been increased and therefore the horizontal force components P1′ and P2′ of the spoke tensions T1′ and T2′ have also been increased. The horizontal forces, which, for example, are effective on the wheel 1′ against the force component P1′ when riding in a rocking pedaling motion, are smaller in relation to P1′ than the same forces relative to P1 in FIG. 1. Only the angle between the spokes 5′ and the center plane of the wheel rim remains small. This lateral rigidity can, however, be increased even more by other means, as will be described further below.

FIG. 4 illustrates an eccentrically spoked bicycle front or rear wheel in side view according to a possible embodiment of the invention. A rear wheel 1′ of this type is shown in axial sectional view in FIG. 3. The depiction essentially corresponds to that in FIG. 2, whereby the wheel also has 24 spokes and these are also crossed on both sides of the wheel.

The most important difference to the conventional wheel in FIG. 2 is the fact, that the number of spokes on one side of the wheel is 16, on the other side of the wheel, however, is 8 and therefore the ratio of the number of spokes 5′ to the number of spokes 7′ is 2:1. This contradicts the principle adhered to up until the present that in spoked bicycle wheels the number of spokes on both sides of the wheel is identical.

The spoke tension ratios T1:T2 in the case of conventionally spoked wheels with some well-known wheel hubs, which result from the dimensions c and d on the hubs and are particularly suitable for this spoke number ratio, are, e.g., the following:

Wheel hub Campagnolo Record, 1990, 8-fold, length 130 mm: c:d=T1:T2=2.13:1.

Wheel hub Shimano Ultegra, 2000, 9-fold, length 130 mm: c:d=T1:T2=1.84:1.

If now a wheel is built with a similar hub and the ratio of c:d=2:1, but with a spoke number ratio of spokes 5′ to spokes 7′ of 2:1, as proposed here, then the spoke tension ratios on the sides of the wheel of 1:1 result, because the spokes on both sides of the wheel will have the same tension. Compare the detail of the hub flange with the detail in FIG. 2. Thus the object is achieved, a stable wheel has been created—and this with very little effort!

In this Figure a table indicates different suitable variants of spoke layouts crossed on both sides of the wheel and analogue design variants with different numbers of spokes. The spokes on the side of the wheel facing the viewer, where there are more spokes, are represented by unbroken lines, the spokes on the other side of the wheel, where there are less spokes, with broken lines. Similar illustrations can be found in the FIGS. 5, 6, 7, 8 and 9.

FIG. 5 shows an eccentrically spoked bicycle front or rear wheel in side view in accordance with another embodiment of the invention. The wheel has 27 spokes in total and the ratio of the number of spokes is once again 2:1 as in FIG. 4. There are 18 crossed spokes represented by unbroken lines on one side of the wheel and 9 radially arranged spokes on the opposite side of the wheel represented by broken lines (hybrid wheel). The overall numbers of spokes indicated in the form of a table are odd numbers and every one of them is divisible by 3. Something of this kind does not exist in the case of conventionally spoked wheels, where the overall number of spokes is always divisible by 2.

Because on the side of the wheel with fewer spokes all spokes are arranged radially, the calculation of the ratio of the spoke tensions T1:T2=c:d has to be corrected, as is indicated in FIG. 1. The dimensional value c is the distance between the center plane of the anchoring points of the spokes in the rim and the axis of the spoke (where the tensile force is effective) at the point of the spoke hole in the flange. If all spokes on this side of the wheel are inserted into the flange from the space between the flanges on the side opposite the sprocket set and then are brought to the wheel rim along the outside edge of the flange—as is usually the case—the dimensional value c is increased by approximately 3 millimeters (the point 8 is displaced towards the outside (here towards the left) by half the thickness of the flange plus half the diameter of the spokes). The dimensional value d, however, is maintained because on the other side of the wheel there are crossed spokes.

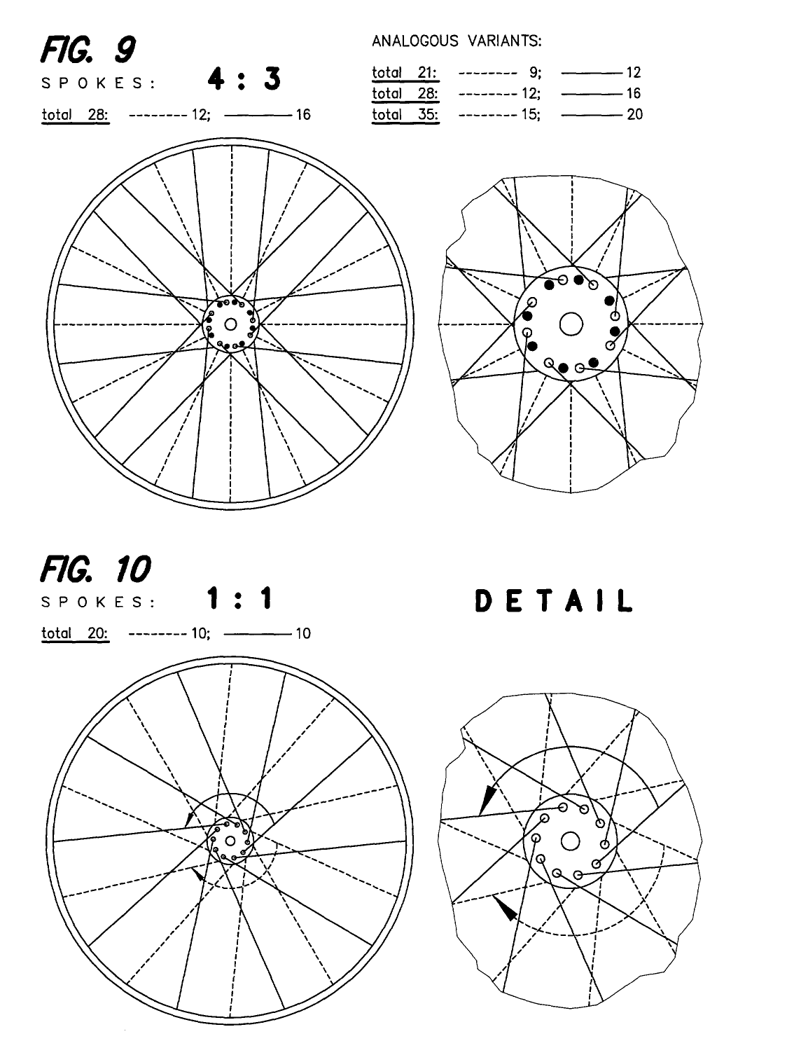

Vice versa, if all spokes from the outer side of the wheel are inserted into the flange on the side of the wheel opposite the sprocket set—which is not customary—, then the dimensional value c is reduced by these 3 millimeters. The dimensional value d is again maintained. These changes can be envisaged with the help of the schematic drawing in FIG. 3. Also in the case of the FIGS. 4 and 6, 7, 8, on the sides of the wheel with less spokes the spokes indicated with broken lines could be mounted radially instead of in crossed manner and then the same correction of the calculation would have to be carried out. Crossed spokes on both sides of the wheel, however, with some exceptions are always more advantageous, as has already been mentioned in connection with FIG. 2. In addition the hub flanges must be approved for radial spoking (see explanations in connection with FIG. 10).

In hybrid running wheels an almost identical tension of the spokes on both wheel sides is not desirable. It is desirable in running wheels which have crossed spokes on both sides when viewed from the side, as is also the case with conventional state of the art running wheels. In this kind of running wheel in operating condition the torque of both flanges is transmitted to the rim (but only by one half of the crossing spokes—the so-called tractive spokes).

In a conventional hybrid running wheel the torque is transmitted by one half of the crossing spokes from only one flange to the rim and these are thus stressed to a higher degree because the radial spokes on the other wheel side do not contribute here. The complete torque in this case is only transmitted via one fourth of all spokes in the wheel (!). In order to achieve a good compromise in the operation of a hybrid running wheel according to the invention and in order to eliminate the peak values the radial spokes are, in a resting condition of the wheel, to have a somewhat higher tension than the crossed spokes. Lower tension e.g. for trekking bicycles, higher tension e.g. for mountain bikes, depending on the dimension of the torque to be expected.

FIG. 6 shows an eccentrically spoked bicycle front wheel or bicycle rear wheel in side view in accordance with a further embodiment of the invention. The wheel has 24 spokes overall, again with the spoke number ratio 2:1 as in the FIGS. 4 and 5. Therefore there are 16 and 8 spokes crossed on both sides of the wheel. The spokes are arranged in groups of three. Very modern at the present time are expensive running wheels, in which the spokes are arranged in a similar manner as here, but in pairs. On a rear wheel of this type, e.g., one sees one pair of the spokes, which are anchored in the wheel rim close to one another, one cannot see, however, that in all cases one of the spokes in the pair has almost double the tension of the other one and correspondingly the wheel cannot be sufficiently stable. The spokes indicated with broken lines could also be spoked radially, but with a corresponding change of the calculation of c:d, as described in connection with FIG. 5. and less transmission of the torque with less spokes.

FIG. 7 illustrates an eccentrically spoked bicycle front wheel or bicycle rear wheel in side view according to another embodiment of the invention. This wheel has 25 spokes overall and the ratio of the spoke numbers here is 3:2(=1.5:1).

The spoke tension ratio T1:T2 in conventionally spoked wheels with several known hubs which result from the dimensional values c and d on the hubs and which are particularly suited to this spoke number ratio are e.g. the following:

Hub Shimano Deore XT, 1996, 7-fold, length 130 mm: c:d=T1:T2=1.58:1.

Hub Shimano Deore LX, 1996, 7-fold, length 135 mm: c:d=T1:T2=1.39:1.

There are 15 and 10 spokes on the two sides of the wheel. The distances between the anchoring points of the spokes in the wheel rim are the same as in the case of all Figures with exception of FIG. 6. Systems of this kind are more suitable for a durable wheel than the system according to FIG. 6, because wheels of this type are better for centering in the case of a lateral wheel wobble. All total spoke number figures indicated in the table are divisible by 5. Here again, similarly as in FIG. 5, the calculation of the ratio of the spoke tensions T1:T2 has to be corrected with the help of c:d. While on both sides of the wheel the spokes are crossed, on the side of the wheel with more spokes, however, there is always, apart from the two crossed spokes, one radial spoke, which is laid out along the outer side of the flange. In this case the dimensional value d must be increased by approximately 1.5 millimeters. If the radial spokes are inserted into the flange the other way round—which is not favorable—then the dimensional value d must be reduced by these 1.5 millimeters. In both cases the dimensional value c is maintained because on this side of the wheel there are only crossed spokes.

FIG. 8 shows a wheel in analogy to FIG. 7. It has 35 spokes overall, with a spoke number ratio of 3:2(=1.5:1). There are 21 and 14 spokes on the two sides of the wheel. Because of the large number of spokes, the wheel is advantageous in instances, when greater stress occurs and/or where an above average durability with many kilometers run is expected (ideal for training bicycles). A very stable rim is recommended. Here again, as in connection with FIG. 7, the dimensional value d must be increased or reduced, depending on the manner in which the spokes are laid out.

FIG. 9 shows an eccentrically spoked bicycle front or rear wheel according to a further embodiment of the invention in side view. The wheel comprises a total of 28 spokes and the spoke number ratio is 4:3(=1.33:1). There are 16 radial spokes and 12 crossed spokes on the two wheel sides (hybrid wheel). The total spoke numbers shown in the table form are divisible by seven. The achieved changing of spoke tension ratio on the wheel sides is relatively small and could be achieved solely with an asymmetrical rim. Corrections of T1:T2 with the help of c:d are possible here as in FIG. 5. The advantageous uniform distances between the anchoring points of the spokes in the rim are also applied here. The position of the spoke holes in the flanges is chosen such that the length of all spokes on each side of the wheel is identical. The hub flanges must be approved for radial spoking, as in FIG. 5.

Other spoke number ratios of the spokes on the wheel sides than described so far and documented in the figures are also possible. We constructed wheels with the ratios 3:1, 5:2, 7:4 and 5:3. The results are usable. Because, however, nobody would be interested in such wheels in the industry today as hubs of suitable dimensions c and d are rarely found we did not include figures showing these ratios. We can supply such sketches to interested parties on demand.

Concerning the spoke systems it must additionally be mentioned that any number of spokes cannot be used on the left and right side of a wheel. Every manner of spoking must be constructed as we have done in the figures. If any spoke ratio would be used on the left and the right side the wheel could not be correctly centered in height and laterally because the distances between the spoke anchorings in the rim would differ considerably and the wheel would additionally be unbalanced. This would lead to dangerous vibrations of the running wheel and the whole bicycle during fast descents. The correlated spoke groups (with 3, 5, 7 or more spokes) must be regularly distributed on the circumference of the rim and be repeated several times, i.e. the running wheel with its spoking must be in rotation symmetry.

FIG. 10 shows a centrically spoked bicycle front wheel in side view according to independent claim 11. This system also increases the durability of a wheel similarly to the eccentrically spoked systems described above. The wheel has a total of 20 spokes, 10 on each side, such that the number of spokes and the spoke tension ratio is 1:1. An even number of spokes is free to choice and it can be spoked to any conventional rim.

This wheel can be compared to any conventional wheel spoked radially on both wheel sides in which the spokes protrude vertically to the spoke hole circle from the flange and reach the rim via the shortest possible distance (radial spokes are e.g. shown in broken lines in FIGS. 5 and 9). Wheels spoked radially on both sides are said to bring slight aerodynamic advantages (no air turbulence where the spokes cross) and the spoke tensions, as is generally known, are more regular here than in systems with crossed spokes. These wheels are still in frequent demand today because they are visually appealing.

Disadvantages: The wheels are, as is generally known, harsh to ride and when they are used for a long time there is, due to the alternating stress on the flanges, the danger that a flange is torn off in the region of the spoke holes, especially with a larger number of spokes. This is why the today's worldwide largest manufacturer of hubs supplies the following written commentary together with every hub sold: “Shimano hubs are not suitable for radial mounting of spokes. Shimano is not obliged to repair or replace hubs on which the spoke holes are deformed due to radial mounting of spokes.”

According to FIG. 10 all spokes on one side of the wheel, shown as continuous lines, leave the spoke hole circle in an almost tangential direction and all spokes on the other side of the wheel, shown as broken lines, do likewise—however in the opposite direction. The continuously drawn arrow and the one drawn in broken lines indicate the directions in which the spokes slightly distort the flanges when the wheel is centered. Thus the cylindrical hub body which connects the flanges is subject to torque in the elastic region of material deformation and the hub body behaves similarly to a torque rod. If, when riding, the average tension of all spokes in the wheel changes momentarily due to operating stress, the torque on the hub body also changes momentarily and this change supports the behavior of the spokes. In order to fulfil this spring-function the hub body must have suitable dimensions. It is not to be too weak (diameter not less than 20 millimeters) and not too rigid. A judgement calculation of the dimensions is to be carried out.

This spoke system has the advantages of the radial system (aerodynamics, regular spoke tension, visually appeal) without its disadvantages. The wheel is even more elastic than any comparable conventionally spoked wheel and therefore also durable and comfortable to ride as the rider does not tire as quickly. The reasons for this are longer spokes and an additional spring effect of the hub body. Most important, however, is that the danger of the spoke holes tearing out does not exist at all here because each spoke leaves the flange in a tangential direction and, in the case of overstressing, would have to tear out a lot more of the flange material than a radial spoke. Hereby it is not significant whether the spokes are inserted from the space between the flanges, as shown in FIG. 10 (which creates more lateral rigidity) of from the outer side of the flange (which is aerodynamically advantageous).

This system cannot be applied to wheels in which the spokes are to transmit a torque. If torque is on hand which is to be transmitted from the hub via the spokes to the rim, the tension of the spokes increases on one side of the wheel while the tension on the other side decreases. This leads to a momentary lateral movement of the rim which can, depending on the dimension of the torque, be several millimeters. The system is neither suitable for all kinds of rear wheels (driving- and/or braking torque) nor for front wheels with a brake on or in the hub. It is suitable for front wheels where the brakes act on the rim sides and these are the most common kind of front wheels. Conventional wheels spoked radially on both sides can in fact also only be used in this manner as they too cannot transmit torque—though due to different reasons (no lever between spoke and wheel axis).

### ADDITIONAL MEASURES

As has already been stated, the object of the present invention is to create an eccentrically spoked wheel with a durability not achieved up until now. This is achieved, according to the invention, by unequal numbers of spokes on the two sides of the wheel. There are, however, other measures, which serve this objective.

One of these is the use of an asymmetrical wheel rim with laterally displaced anchoring points of the spokes in the direction towards the side of the wheel opposite the sprocket set. The ratio of the dimensions c:d on the wheel hub and therefore also the important spoke tension ratio of T1:T2, as a result of this, are reduced significantly in the calculation, because the dimensional value c is reduced and simultaneously the dimensional value d is increased. With this, the lateral rigidity of the wheel in the direction from the sprocket set or from the brake disc towards the other side of the wheel increases and the durability of the wheel is also improved.

Another measure is to insert conventional spokes, which are bent at their ends, into conventional flanges only from one side (see claim 12). This is especially interesting for radial spoking (FIG. 5, 9) but also for spoking which is crossed in lateral view, where the spokes cross at a sufficient distance from the flange (e.g. such as the spokes shown as broken lines in FIG. 4 or 6). The spokes can e.g. be inserted into both flanges from the outside or from the inside or into one flange from the outside and into the other one from the inside. Or crossed spokes can be inserted alternatingly from both sides of the one flange while the other flange is spoked from only one side. The measures influence the size of the dimensional values c and d which were measured on the hub and the important ratio c:d then changes, as in the case of dimensional value c described in FIG. 5. Thus the spoke tension ratio T1:T2 which results from the dimensional values c and d on the hub can be corrected in the desired direction.

Another measure is a sufficiently large distance between the flanges on the wheel hub (2b=c+d). In this, the lengths 2a and d have to be maintained and solely the dimension c is increased. It is beyond any doubt, that the lateral rigidity of a wheel increases with the increasing distance of the flanges from one another, and this in the direction from both sides of the wheel. It is surprising, that this finding even today still is being ignored also by noted manufacturers, or else is not known. At the present moment, in the case of conventional rear wheels this distance in accordance with a well-known rule is maintained at a value of approximately 54 (±1 millimeter). In the case of a too small distance of, for example, less than 50 millimeters, the lateral rigidity and the durability of the wheel are reduced to a high degree. Vice versa, in the case of a too large distance of, e.g., more than 60 millimeters, the ratio of the spoke tensions increases to values of more than 2:1 and in operation very soon a loosening of the nipples of spokes with a too low tension takes place and therefore a lateral wheel wobble results. In the case of special wheels this phenomenon is eliminated by the use of special nipples with an insert made of plastic material. The very great tension of the spokes on the sprocket set side of the wheel is countered by use of especially thicker spokes on this side of the wheel. These special components are difficult to obtain as spares for repair. The great difference in the tension of the spokes on both sides of the wheel, however, remains unchanged and the whole solution of the problem for this reason is unsatisfactory.

### PRACTICAL ADVICE

See FIG. 1.

In the case of a rear wheel hub for a racing bicycle with the following dimensions in millimeters: 2a=130; c=35; d=19; distance of the wheel hub flanges c+d=54, the ratio of the spoke tensions T1:T2=c:d=35:19=1.84:1. In the case of a conventional spoking of a wheel with this hub (left-hand and right-hand spokes are crossed, the anchoring of the spokes in the wheel rim lies in its center and the number of the spokes on both sides of the wheel is the same), therefore the average tension of the spokes 5 on the right (on the more stressed wheel hub sprocket set side) is 1.84—times greater than the tension of the spokes 7 on the left (on the less stressed opposite side of the wheel hub).

Examples of the spoke tensions in wheels with the described wheel hub exploiting various claims:

1) Utilization of the number of spokes of the spokes 5′ to the spokes 7′ in the ratio of 3:2(=1.5:1)—refer to FIGS. 7 and 8.

The original spoke tension ratio of 1.84:1 as a result of this is reduced 1.5—times, such that T1′:T2′=1.84:1.5=1.23:1.

One can make good use of the wheel, the new spoke tension ratio of 1.23:1 is much more favorable than the original one of 1.84:1 and is situated low in the acceptable range (up to approximately 1.4:1). One requires a conventional wheel hub and a conventional wheel rim, only the number of spokes on the left-hand and right-hand side of the wheel is now different. For reasons described previously, it is advantageous, if there are crossed spokes on both sides of the wheel.

2) Use of the spoke number ratio of 3:2 (as in case 1) and secondly, use of an asymmetrical wheel rim with spoke anchoring points displaced by 3 millimeters in the direction of the side opposite the sprocket set of the wheel.

First, as in the case 1): The original spoke tension ratio of 1.84:1 is reduced 1.5-times.

Second, the original ratio of c:d=35:19=1.84:1 changes due to the displacement of the spoke anchoring in the wheel rim by 3 mm to (c−3):(d+3)=32:22=1.45:1. As a result of this, the original ratio of 1.84:1 is reduced for the second time, this time (1.84:1.45=) 1.27-times.

The final spoke tension ratio T1′:T2′=(1.84:1.5):1.27=0.97:1.

Thus the ideal spoke tension ratio of 1:1 is practically achieved. For this excellent solution one requires a spoke number ratio of 3:2 and an asymmetrical wheel rim. Wheel rims of this kind have been on the market for many years. They not only improve the spoke tension ratio of both sides of the wheel, but also make the wheel significantly more rigid in the direction from the sprocket set side to the side opposite the sprocket set. Crossed spokes on both sides of the wheel are advantageous.

3) Use of the spoke number of the spokes 5′ to the spokes 7′ in the ratio of 2:1 (refer to FIGS. 4, 5, 6).

The original spoke tension ratio of 1.84:1 as a result of this is reduced 2-times, so that T1′:T2′=1.84:2=0.92:1.

The wheel can be made good use of, the new spoke tension ratio of 0.92:1 is much more favorable than the original one of 1.84:1. One requires a conventional wheel hub and a conventional wheel rim, only the number of the spokes on the left- and right-hand side of the wheel is now different. Because the tension T1′ on the right-hand side is now smaller than the tension T2′ on the left-hand side, this solution is advantageous in the case of those spoke systems, where all spokes on the left are radially spoked (FIG. 5), so that the torque is transmitted exclusively through the right-hand crossed spokes. On these hybrid wheels further correction of the spoke tensions can be achieved by inserting the radial spokes into the flange from only one side.

4) Use of the number of spokes ratio of 2:1 (as in the case 3), secondly, use of an asymmetrical wheel rim with spoke anchoring points displaced by 3 millimeters in the direction towards the side of the wheel opposite the sprocket set (as in the case 2) and third, utilization of a wheel hub body extended in the direction towards the side of the hub opposite the sprocket set.

First, as in the case 3): The original spoke tension ratio of 1.84: 1 is reduced 2-times.

Second, as in the case 2): The original ratio of c:d=35:19=1.84:1 changes as a result of the displacement of the spoke anchoring in the wheel rim to 1.45:1. The original ratio of 1.84:1 is, because of this, reduced for the second time, this time by (1.84:1.45=) 1.27-times. The spoke tension ratio T1′:T2′ up until now would be (1.84:2):1.27=0.724:1.

Now the tension T1′ would be too small, T2′ too big. For this reason, additionally, a new wheel hub is used, which has to be specially manufactured. The original dimension d=19 is maintained, but the dimension c=35 on the wheel hub body is increased (1:0.724)-times, so that c (new) =35×(1:0.724)=48.34. The new wheel hub has the following dimensions: 2a=130; c=48.34 (new); d=19; distance of the flanges =c+d=67.34 (new); c:d=2.54:1 (new).

The final spoke tension ratio T1′:T2′=(0.724:1)×(1:0.724)=1:1.

Mathematically the ideal dimensions of the wheel hub and therefore also the ideal spoke tension ratio of T1′:T2′=1:1 have been achieved. For this solution a spoke number ratio of 2:1 (as in the case 3) is required, an asymmetrical wheel rim (as in the case 2) and new, a new design of the wheel hub on its left-hand side. As a result of this a rear wheel is obtained, with which the rear wheels known up until now cannot compare and are much more expensive. The asymmetrical wheel rim improves the rigidity of the wheel from the right. The wheel hub with a greater distance of the flanges additionally provides the wheel with a greater rigidity from the right and from the left. The spoke tension ratio of 1:1 prevents spoke fractures and lateral wheel wobble, which are produced by irregular settling phenomena in the anchoring points of the spokes. It is a very important point that the wheel can be repaired very easily, because it has conventional spokes and nipples, which are cheap and which can be purchased everywhere. In the case of this wheel, again, crossed spokes on both sides of the wheel are to be recommended (FIGS. 4, 6).

The four described examples show (all using a hub of the dimensional values c:d=35:19=1.84:1) that the aspired to spoke tension ratio of 1:1 on the wheel sides is only achieved precisely in example 4). Two additional measures must, however, be taken in this case: the asymmetrical rim and a totally newly designed precision hub. A wheel manufacturer will, however, for reasons of cost, only rarely favor this kind of design. In example 2) a ratio of 0.97:1 is achieved with the help of the asymmetrical rim. This rim is not readily available at the moment or not desired due to different reasons. Without any additional measures a ratio of 0.92:1 is achieved with the mentioned hub in example 3) and 1:1.23 is achieved in example 1). The ratio of 1:1.23, however, means 23% divergence from the aspired to spoke tension ratio of 1:1. If the aim is to do without additional measures, which will mostly be the case, this divergence can reach 45% or more. There are even hubs with dimensional values c and d in the value of ca. 2.5:1 (!) on the market.

The fact that the spoke tension ratio of 1:1 can mostly only be achieved with certain divergences is caused due to the fact that there are countless ratios of the dimensional values c and d on hubs on the market which determine the spoke tension ratio on the sides of a conventional wheel but only few spoke number ratios exist which act against the disadvantageous conventional tension ratios and which are technically practicable and practically usable (see explanations referring to FIG. 9). Only rarely a spoke number ratio can be used on the wheel sides which is nearest to the ratio c:d on the hub. Therefore it is, due to different reasons, necessary to use ratios of spoke numbers which are more distant. With some of the ratios suggested here the possible total number of spokes in the wheel is insufficient and thus these ratios are not always applicable. The defining of the position of the spoke holes in the rim and in the hub is complicated. The distances between the anchoring points of the spokes in the rim are varying which makes the wheel optically unsatisfactory. There are several different lengths of spokes in the rim, the spoking of the wheel is complicated by this etc.

Divergences of zero to plus/minus 50% from the aspired to ratio of spoke tensions of 1:1 (practically these divergences will on average amount to less than 20%), however mean a large improvement compared to the state of the art. According to diverse tests this kind of wheel is considerably more durable than conventional wheels. The divergences of the ratios of the spoke tensions on the wheel sides from the ratio 1:1 are ca. 50% on conventional wheels of today, 100% (see descriptions of hubs in the explanations concerning FIGS. 7 and 4) or even 150% (!), according to the available hubs used.

### RECOMMENDATIONS, EXPERIENCES UP UNTIL NOW

The spoking of the new wheels is as simple as in the case of the conventional wheels. The centering by hand is even more easy, because the nipples can be turned on both sides of the wheels without greater resistance. For the centering with an automatic machine, the machine would have to be re-programmed. Important is the higher average spoke tension (of approximately 1′000 N and more), which should be measured with a spoke tension measuring device at least at certain time intervals, and the multiple straining and stretching of the wheel during centering. A good running wheel must have a good, not too light wheel rim, e.g. an aerody-namically shaped rim on a racing bicycle, approximately 19 mm wide and 20 mm high and not less than approx. 430 g in weight (asymmetrical wheel rims with laterally displaced spokes and symmetrical wheel rims with these characteristics are available on the market), conventional quality spokes and good conventional milled brass nipples. Furthermore regular spacing of the anchoring points of the spokes in the wheel rim with the spokes crossed on both sides and overall not considerably less than 24 spokes are to be strongly recommended. Careful spoking and centering prevails.

For the simplification of the spoking of a wheel and for reasons of cost, we recommend the following: The bores for the spoke nipples in the wheel rim (at the center of it or laterally displaced) should be implemented to be as simple as possible. All holes should be in a line (no zigzag lines) and should be drilled in radial direction (vertical to the wheel axis). Directional orientations of the bores forwards, backwards, to the left or to the right are expensive, unnecessary and confusing when carrying out the spoking. A sufficient diameter of the bores has to be assured, so that the nipples if so required can assume an inclined position in the bore on their own. The bore diameter is the diameter of the cylindrical part of the nipple utilized with an overmeasure allowance of approximately 0.4 to 0.5 millimeters depending on the thickness of the bored material and not only around 0.2 millimeters, as is customary in the case of directionally oriented bores.

Prototypes for trial purposes are simple to manufacture, because conventional wheel hubs, spokes, nipples and wheel rims can be used. Only the number and the position of the holes for the spokes in the wheel hub and in the rim are now different. Conventional rims and hubs without holes must be obtained and the holes must then be bored in the correct places. Hereby the position of the holes in the rim (excepting FIG. 6) are simply determined (regular mutual distances on the circumference of the rim with a known number of holes) and the bores are to be executed according to the above instructions. The exact positions of the holes and the mutual relations between these positions in the two hub flanges must be determined, which presents no problems to the experienced specialist. The details in the figures can be of additional help here.

There is no optimum value for an average spoke tension on all wheels. The aspired maximally possible tension which effects the maximal lateral rigidity of the wheel is determined by the rim and the number and arrangement of the spokes. If this tension is exceeded when centering, the stability of the wheel decreases again rapidly. The danger of this happening mainly occurs where weak rims and a large number of spokes (e.g. 30 and more) is used. The experienced constructor of wheels knows the corresponding methods to determine the optimum value. When an optimum tension has been determined it can be measured with a measuring instrument and stored.

So far there is little empirical experiences in the operation of the wheels. A few such wheels are under permanent operation and have so far not shown signs of fatigue. What can be foreseen at present is that according to permanent tests with wheels with asymmetrical rims their durability has substantially increased in relation to conventional wheels. The main reason for this is the improvement of the spoke tension ratio by ca. 30%. Here, however, we are dealing with an improvement of this ratio of up to 100% (!) due to which a further increase of durability is to be expected. Vibrations of the bicycle when going fast—such as theoreticians might fear—are largely unknown.

With what has been described up to now, the spoke tension in the case of eccentrically spoked bicycle wheels can be standardized. The method in accordance with the invention is the following one: In that the wheel hub at the individual sides of the center plane of the wheel rim M is equipped with a correspondingly not equal number of anchored spokes, the average tension of the spokes, to such an extent as this is desired, can be equalized. As already described, the total tensions of the spokes, which lead from the wheel hub on the one, respectively, on the opposite side of the center plane of the wheel rim M in the direction towards the wheel rim, are of a different value. This can be equalized by means of the differing numbers of anchored spokes.

### THE FUTURE

The possibilities for the exploitation of the invention described here have absolutely not been dealt with exhaustively. Over the course of time, assuredly spoke systems unknown up until the present moment will be created which will increase the durability of wheels. All the same, all these new variants are covered by the claim 1, whereby the number of the spokes on each side of an eccentrically spoked bicycle wheel is different. An independent claim 17 for a centrically spoked wheel with the same number and tension of the spokes on the sides of the wheel will increase the durability of the wheel in another manner.

The inventor is of the opinion, that this invention will revolutionize the spoking of running wheels. Every manufacturer of bicycles or running wheels of note will sooner or later be compelled to give serious thought to this. It is a very infrequent occasion, that a problem, which has been known for decades and which has become bigger and bigger and for the solution of which the world's largest companies have been mobilizing the most diverse means and great expenses, can be eliminated in such a manner. The spoke systems with spoke number ratios of 3:1, 5:2, 2:1, 7:4, 5:3, 3:2 and 4:3, supported by “ADDITIONAL MEASURES” largely allow optimizing of the spoke tensions on both wheel sides using any kind of hub and the regular structure of the wheel then guarantees its durability. Our solution to the problem of extremely undesirable unequal spoke tensions on the two sides of a bicycle wheel is very astonishing. It is, however, by far the most simple, the cheapest and the most perfect solution to the problem.

1. Spoked bicycle wheel consisting of a hub, which is connected by means of spokes under tension to a ring shaped rim, with an unequal number of spokes on the two sides of the wheel, in the case of which the center plane of the anchoring points of the spokes in the rim is laterally displaced from the center plane of the hub flanges or from the center plane of differently constructed anchoring points on the sides of the hub (F), characterized in that
the number of spokes, which from the hub on that side of the center plane of the rim (M) lead in the direction towards the rim, on which a higher sum of the tensions of these spokes is present and the number of spokes, which from the hub on the opposite side of the center plane (M) of the rim lead in the direction towards the rim, on which a lower sum of the tensions of the spokes is present is at a mutual ratio of 3:1 or 5:2 or 2:1 or 7:4 or 5:3 or 3:2 or 4:3.

2. Spoked bicycle wheel according to claim 1, characterized in that
the spokes number ratio of 3:1 or 5:2 or 2:1 or 7:4 or 5:3 or 3:2 or 4:3 diverges by zero to plus or minus 50 percent from the ratio of the dimensional values c:d, which are measured on the hub used and are possibly corrected when calculating c:d by means of the measures described in claims 11, 12 or 13, whereby:
c is measured between the radial center plane of the axes of the spokes anchored in the hub, which spokes are lead from the hub on that side of the center plane (M) of the rim in the direction towards the rim where a lower total tension of these spokes is present, in the locations, where the spokes leave the hub and have only just reached the direction towards the rim and the radial center plane of the axes of all the spokes anchored in the rim, in those locations, in which the spokes leave the rim and have just reached the direction towards the hub and
d is the analogue value to c on the opposite side of the center plane (M) of the rim where a larger total tension of the spokes anchored in the hub is present, whereby the ratio of the average tension of the spokes, which from the hub on the one side of the center plane (M) of the rim lead in the direction towards the rim and the average tension of the spokes, which lead from the hub in the direction towards the rim on the other side of the center plane (M) of the rim diverges by zero to plus or minus 50 percent from the ratio 1:1.

3. Spoked bicycle wheel according to claim 1 or 2, characterized in that
the number of spokes, which from the hub on the one side of the center plane (M) of the rim lead in the direction towards the rim and the number of those spokes, which from the hub on the other side of the center plane (M) of the rim lead to the rim, is in the ratio of c:d, whereby
the average tension of the spokes which lead from the hub on the one side of the center plane (M) of the rim in the direction towards the rim and the average tension of those spokes which lead from the hub on the other side of the center plane (M) of the rim in the direction towards the rim is at a ratio of 1:1.

4. Spoked bicycle wheel according to claim 1 or 2 to 3, characterized in that the number of spokes, which from the hub on the one side of the center plane (M) of the rim lead in the direction towards the rim and the number of those spokes, which from the hub on the other side of the center plane (M) of the rim lead to the rim, is at a ratio of 3:1.

5. Spoked bicycle wheel according to claim 1 or 2 to 3, characterized in that the number of spokes, which from the hub on the one side of the center plane (M) of the rim lead in the direction towards the rim and the number of those spokes, which from the hub on the other side of the center plane (M) of the rim lead to the rim, is at a ratio of 5:2.

6. Spoked bicycle wheel according to claim 1 or 2 to 3, characterized in that the number of spokes, which from the hub on the one side of the center plane (M) of the rim lead in the direction towards the rim and the number of those spokes, which from the hub on the other side of the center plane (M) of the rim lead to the rim, is at a ratio of 2:1.

7. Spoked bicycle wheel according to claim 1 or 2 to 3, characterized in that the number of spokes, which from the hub on the one side of the center plane (M) of the rim lead in the direction towards the rim and the number of those spokes, which from the hub on the other side of the center plane (M) of the rim lead to the rim, is at a ratio of 7:4.

8. Spoked bicycle wheel according to claim 1 or 2 to 3, characterized in that the number of spokes, which from the hub on the one side of the center plane (M) of the rim lead in the direction towards the rim and the number of those spokes, which from the hub on the other side of the center plane (M) of the rim lead to the rim, is at a ratio of 5:3.

9. Spoked bicycle wheel according to claim 1 or 2 to 3, characterized in that the number of spokes, which from the hub on the one side of the center plane (M) of the rim lead in the direction towards the rim and the number of those spokes, which from the hub on the other side of the center plane (M) of the rim lead to the rim, is at a ratio of 3:2.

10. Spoked bicycle wheel according to claim 1 or 2 to 3, characterized in that the number of spokes, which from the hub on the one side of the center plane (M) of the rim lead in the direction towards the rim and the number of those spokes, which from the hub on the other side of the center plane (M) of the rim lead to the rim, is at a ratio of 4:3.

11. Spoked bicycle wheel according to claim 1 or one of the claims 2 to 10, characterized in that it comprises a rim, in which the center plane of the anchoring points of the spokes in the rim is laterally displaced from the center plane (M) of the rim.

12. Spoked bicycle wheel according to claim 1 or one of the claims 2 to 11, which comprises conventional hub flanges with spoke holes running in parallel to the axis of the wheel and conventional spokes bent at their ends and comprising a spoke head, characterized in that all spokes anchored in the flange are inserted into in the direction of only one flange side, whereby different combinations of these directions can be formed on a wheel.

13. Eccentrically spoked bicycle rear wheel according to claim 1 or one of the claims 2 to 12, characterized in that it comprises a rear wheel hub, in which the distance between the center planes of the hub flanges or between the center planes of otherwise designed anchoring points of the spokes on the sides of the hub (c+d), amounts to 58 or more millimeters.

14. Spoked bicycle wheel according to claim 1 or one of the claims 2 to 13, characterized in that it comprises a sticker on the hub and/or on the rim with an inscription of a suitable text, which draws attention to the unaccustomed and for the spoking and centering of the wheel important arrangement of the spokes on the sides of the wheel.

15. A bicycle with at least one spoked wheel according to claim 1 or one of the claims 2 to 14.

16. Method for the standardization of the spoke tensions in the case of eccentrically spoked bicycle wheels, in which the average tension of the spokes, which from the hub on that side of the center plane (M) of the rim lead in the direction towards the rim, where a greater overall tension of the anchored spokes is present, is equalized to such an extent as is desired with the average tension of those spokes, which from the hub on the opposite side of the center plane (M) of the rim lead in the direction towards the rim, where a lower overall tension of the anchored spokes is present, in that the hub on the individual sides of the center plane (M) of the rim is equipped with a correspondingly unequal number of anchored spokes.

17. Spoked bicycle front wheel consisting of a wheel hub, which by means of spokes is connected with a ring-shaped wheel rim under tension, with identical number and tension of the spokes on both wheel sides, characterized in that all spokes, which lead from the wheel hub on one side of the center plane (M) of the rim in the direction towards the rim leave the spoke holes circle in a direction more or less tangential to the spoke holes circle and all spokes which lead from the hub in the direction towards the rim on the other side of the center plane (M) of the rim also leave the spoke holes circle in a direction more or less tangential to the spoke holes circle, however in the opposite circumference direction of the wheel.
